(19) United States
(12) Patent Application Publication
(10) Pub. No.: US 2026/0361954 A1
(43) Pub. Date: Nov. 12, 2026

(54) METHOD, APPARATUS, MEDIUM, DEVICE, AND PRODUCT FOR DETERMINING DISPLAY INFORMATION

(71) Applicant: Beijing Zitiao Network Technology Co., Ltd., Beijing (CN)

(72) Inventors: Yuzhong CHEN, Beijing (CN); Wei ZHUO, Beijing (CN)

(21) Appl. No.: 19/669,622

(22) Filed: May 6, 2026

(30) Foreign Application Priority Data
May 6, 2025 (CN) 202510580277.4

(51) Int. Cl. H04N 21/442; H04N 21/466; H04N 21/472; H04N 21/81

(52) U.S. Cl. CPC H04N 21/44204; H04N 21/4667; H04N 21/472; H04N 21/812

(57) ABSTRACT

A method and an apparatus for determining display information, a medium, a device and a product. The method includes: determining an expected playback duration, where the expected playback duration is an expected playback duration of a first user for a first multimedia content, and the first target multimedia content is a multimedia content to be played in a first page after switching in response to a page switching operation implemented by the first user being received; and determining a second display time of a target component according to the expected playback duration and a preset first display time of the target component, where the display time of the target component is used to indicate an opportunity to start displaying the target component on the first page in a process of playing the first target multimedia content, and the target component is used to trigger display of a landing page associated with the first target multimedia content.

### CROSS-REFERENCE TO RELATED APPLICATIONS

The present application is based on and claims priority of CN Application No. 202510580277.4, filed on May 6, 2025, the disclosure of which is incorporated by reference herein in its entirety.

### TECHNICAL FIELD

The present disclosure relates to the field of computers, and in particular, to a method, an apparatus, a medium, a device, and a product for determining display information.

### BACKGROUND

Multimedia content, such as videos, may provide users with rich information. In the process of playing the multimedia content, components may also be displayed on the page where the multimedia content is played. The components may be, for example, components for product promotion, components for news push, components for interacting with users, and so on.

### SUMMARY

The part of the summary is provided so as to introduce the concept in a brief form, and these concepts will be described in detail in the following part of detailed description. The part of the summary is not intended to identify the key features or necessary features of the claimed technical solution, nor is it intended to limit the scope of the claimed technical solution.

In a first aspect, the present disclosure provides a method for determining display information, the method includes:
determining an expected playback duration, the expected playback duration is an expected playback duration of a first user for a first target multimedia content, the first target multimedia content is multimedia content to be played in a first page after switching in response to a page switching operation implemented by the first user being received; and
determining a second display time of a target component according to the expected playback duration and a preset first display time of the target component, where the display time of the target component is used to indicate an opportunity to start displaying the target component on the first page in a process of playing the first target multimedia content, and the target component is used to trigger display of a landing page associated with the first target multimedia content.

In a second aspect, the present disclosure provides an apparatus for determining display information, the apparatus includes:
a first determination module, configured to determine an expected playback duration, the expected playback duration is an expected playback duration of a first user for a first target multimedia content, the first target multimedia content is multimedia content to be played in a first page after switching in response to a page switching operation implemented by the first user being received; and
a second determination module, configured to determine a second display time of a target component according to the expected playback duration and a preset first display time of the target component, where the display time of the target component is used to indicate an opportunity to start displaying the target component on the first page in a process of playing the first target multimedia content, and the target component is used to trigger display of a landing page associated with the first target multimedia content.

In a third aspect, the present disclosure provides a computer-readable medium having a computer program stored thereon, where the computer program, when executed by a processing apparatus, implements the steps of the method for determining display information provided by the first aspect of the present disclosure.

In a fourth aspect, the present disclosure provides an electronic device, including:
a storage apparatus having a computer program stored thereon; and
a processing apparatus, configured to execute the computer program in the storage apparatus to implement the steps of the method for determining display information provided by the first aspect of the present disclosure.

In a fifth aspect, the present disclosure provides a computer program product including a computer program, where the computer program, when executed by a processor, implements the steps of the method for determining display information provided by the first aspect of the present disclosure.

Other features and advantages of the present disclosure will be described in detail in the following part of detailed description.

### BRIEF DESCRIPTION OF THE DRAWINGS

The above and other features, advantages, and aspects of the embodiments of the present disclosure will become more apparent in combination with the drawings and with reference to the following specific embodiments. Throughout the drawings, the same or similar reference numbers refer to the same or similar elements. It should be understood that the drawings are schematic, and the components and elements are not necessarily drawn to scale. In the drawings:

FIG. 1 is a flowchart of a method for determining display information shown as an example.

FIG. 2 is a schematic diagram of a first page shown as an example.

FIG. 3 is a flowchart of a method for determining an expected playback duration shown according to an exemplary embodiment.

FIG. 4 is a flowchart of a method for training a duration determination model shown according to an exemplary embodiment.

FIG. 5 is a schematic diagram of a first page shown as an example.

FIG. 6 is a block diagram of an apparatus for determining display information shown according to an exemplary embodiment.

FIG. 7 shows a schematic structural diagram of an electronic device suitable for implementing the embodiments of the present disclosure.

### DETAILED DESCRIPTION OF EMBODIMENTS

Hereinafter, embodiments of the present disclosure will be described in more detail with reference to the drawings. Although some embodiments of the present disclosure are shown in the drawings, it should be understood that the present disclosure may be implemented in various forms, and should not be interpreted as limited to the embodiments set forth herein. Instead, these embodiments are provided for a more thorough and complete understanding of the present disclosure. It should be understood that the drawings and embodiments of the present disclosure are only for exemplary purposes, and are not intended to limit the protection scope of the present disclosure.

It should be understood that the various steps described in the method implementations of the present disclosure may be executed in different orders and/or in parallel. Furthermore, the method implementations may include additional steps and/or omit execution of the steps shown. The scope of the present disclosure is not limited in this regard.

As used herein, the term “include/comprise” and its variants are open-ended inclusions, namely, “include/comprise but not limited to”. The term “based on” is “based at least in part on”. The term “an embodiment” means “at least one embodiment”; the term “another embodiment” means “at least one other embodiment”; the term “some embodiments” means “at least some embodiments”. Relevant definitions of other terms will be given in the following description.

It should be noted that concepts such as “first” and “second” mentioned in the present disclosure are only used to distinguish different apparatuses, modules, or units, and are not used to limit the sequence or interdependence of the functions performed by these apparatuses, modules, or units.

It should be noted that the modifiers of “a” and “a plurality of” mentioned in the present disclosure are schematic rather than restrictive, and those skilled in the art should understand that they should be understood as “one or more” unless otherwise clearly indicated in the context.

The names of messages or information exchanged between multiple apparatuses in the implementations of the present disclosure are only for illustrative purposes, and are not intended to limit the scope of these messages or information.

It may be understood that before using the technical solutions disclosed in the embodiments of the present disclosure, the user should be informed of the type, range of use, use scenarios, etc., of personal information involved in the present disclosure in an appropriate manner in accordance with relevant laws and regulations, and the authorization of the user should be obtained.

For example, in response to receiving an active request from a user, prompt information is sent to the user to clearly prompt the user that the requested operation will require access to and use of personal information of the user. In this way, the user may independently choose, according to the prompt information, whether to provide the personal information to software or hardware, such as an electronic device, an application, a server, or a storage medium, that performs the operations of the technical solutions of the present disclosure.

As an optional but non-limiting implementation, in response to receiving the active request from the user, the prompt information may be sent to the user in the form of, for example, a pop-up window, and the prompt information may be presented in text in the pop-up window. Furthermore, the pop-up window may also carry a selection control for the user to choose whether to “agree” or “disagree” to provide the personal information to the electronic device.

It may be understood that the above process of notifying and obtaining user authorization is only schematic, and does not constitute a limitation on the implementations of the present disclosure, and other manners that satisfy the relevant laws and regulations may also be applied to the implementations of the present disclosure.

At the same time, it may be understood that the data involved in the technical solution (including but not limited to the data itself, acquisition or use of the data) should comply with the requirements of corresponding laws, regulations, and related provisions.

Taking short videos as an example, an application for playing short videos may allow a user to continuously browse multiple short videos, that is, the user may continuously browse the multiple short videos through a page switching operation such as an up-sliding operation. At present, product promotion, news push, etc., may be carried out through short videos. Taking product promotion as an example, a short video may be an advertisement video in which a promoter introduces a relevant product, and a component for product promotion, namely, an advertisement component, may be displayed on the page where the short video is played. For example, the advertisement component includes an introduction of and a purchase link to the relevant product. In order to reduce the obviousness of advertisement delivery in short videos, the advertisement component is not displayed when the short video starts to be played, but is displayed on the page only after a period of time, such as 5 seconds, of playing. The inventor(s) found that different users switch pages at different speeds, and if a user switches pages relatively fast, the situation may occur that the user has already switched to the next page while the advertisement component has not been displayed yet, resulting in a relatively low click-through rate of the advertisement component and a relatively low conversion rate of the advertisement, and thus poor effectiveness of the advertisement delivery.

In view of this, the present application provides a method, an apparatus, a medium, a device, and a product for determining display information, so as to increase the probability of a first user seeing a target component, thereby increasing the click-through rate of the target component.

Through the above technical solution, the expected playback duration is the expected playback duration of the first user for the first target multimedia content, and the first target multimedia content is the multimedia content to be played in the first page after switching in response to the page switching operation implemented by the first user being received, that is, the playback duration of the first target multimedia content to be displayed may be estimated. The second display time of the target component is determined according to the expected playback duration and the preset first display time of the target component. In this way, in response to the preset first display time of the target component being later than the time corresponding to the expected playback duration, the display opportunity of the target component in the first page may be advanced. In response to the page switching operation implemented by the user being received, the display opportunity of the target component is advanced in the process of playing the first target multimedia content, which may increase the probability of the first user seeing the target component, thereby increasing the click-through rate of the target component.

FIG. 1 is a flowchart of a method for determining display information shown as an example, and the method may be applied to an electronic device, such as a terminal device, like a mobile phone, a tablet computer, etc. As shown in FIG. 1, the method for determining display information may include step 11 and step 12.

In step 11, an expected playback duration is determined.

The expected playback duration is an expected playback duration of a first user for a first target multimedia content, and the first target multimedia content is multimedia content to be played in a first page after switching in response to a page switching operation implemented by the first user being received.

In the present disclosure, the multimedia content being a short video is taken as an example for explanation. In a scenario, the first user has already opened an application installed on the electronic device and used for playing short videos, and short video 1 is being played on a current page of the application, that is, the first user is viewing short video 1. In a process of playing short video 1, in response to the first user implementing the page switching operation, such as an up-sliding operation, short video 2 to be played in the first page after switching, that is, the first target multimedia content, has already been determined by the electronic device. For example, short video 2 may be a short video that may be of interest to the first user and that is determined according to any video pushing algorithm in the related art. In the process of playing short video 1 on the current page, that is, when the first user has not yet implemented the page switching operation, the method for determining display information of the present disclosure may be executed.

In another scenario, the page switching operation may be an operation of opening the short video application implemented by the first user, the first page after switching is a video play page first displayed after the short video application is opened, and the first target multimedia content is a first short video played after the short video application is opened. Then, after receiving the operation of opening the short video application implemented by the first user, in a process of video buffering or loading, the method for determining display information of the present disclosure may be executed.

The expected playback duration is the expected playback duration of the first user for the first target multimedia content, which may be seen as an expected duration that the first user stays on the first page. For example, the expected playback duration of 3 seconds may represent that it is expected that the first user may switch to a next video when the first target multimedia content is played to the third second.

In addition, in the present disclosure, the multimedia content may also be audio content, and the user may click a previous one and a next one to switch audio play pages.

In step 12, a second display time of the target component is determined according to the expected playback duration and a preset first display time of the target component.

The display time of the target component is used to indicate an opportunity to start displaying the target component on the first page in a process of playing the first target multimedia content, and the target component is used to trigger display of a landing page associated with the first target multimedia content.

The target component may be a page component to be displayed on the first page. One or more target components may be displayed on the first page, and which target component or components are to be displayed on the first page may be preset, for example, by a creator of the first target multimedia content. Exemplarily, the target component may include an introduction of and a purchase link to a relevant product, and the first user may click the target component to trigger display of the landing page associated with the first target multimedia content, the landing page being, for example, a detailed introduction page or a purchase page of the relevant product.

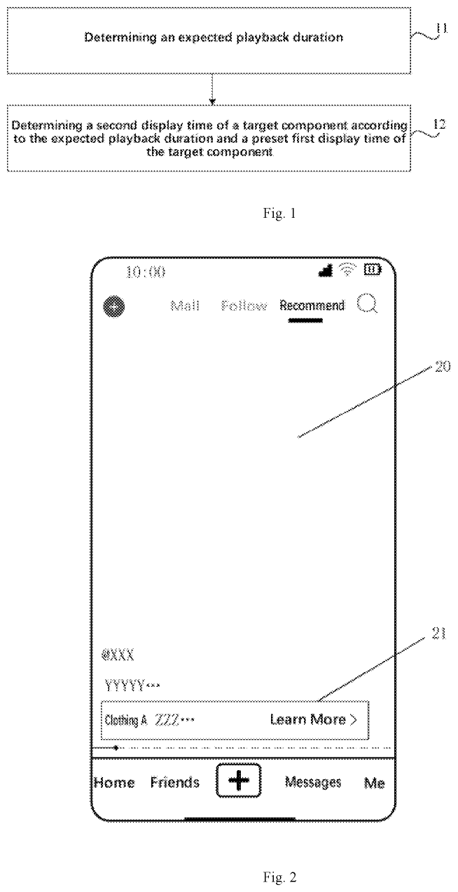

FIG. 2 is a schematic diagram of a first page shown as an example, and as shown in FIG. 2, the first page 20 is a page for playing the first target multimedia content. It should be noted that the first page 20 is not a page currently seen by the first user, the page currently seen by the first user is a current page, and the first page 20 is a page seen by the first user in response to the first user implementing the page switching operation on the current page and the electronic device executes a page switching instruction. Exemplarily, the first target multimedia content includes, for example, content for promoting clothing A, that is, an advertisement video of clothing A, and the target component 21 may include an introduction ZZZ of clothing A and a purchase link of clothing A, the purchase link being reflected through “learn more”. As shown in FIG. 2, XXX is a creator of the first target multimedia content, and YYY is a description text of the first target multimedia content. A playback progress bar of the first target multimedia content is below the target component 21.

The preset first display time of the target component is used to indicate a preset opportunity to start displaying the target component on the first page in the process of playing the first target multimedia content. The first display time may be preset by the creator of the first target multimedia content, that is, the creator desires to start displaying the target component in a certain second, or may be a parameter set in the application, for example, in which second the target component usually starts to be displayed. As an example, for example, the preset first display time is the fifth second, which means that it is preset that when the first target multimedia content is played to the fifth second, the target component starts to be displayed on the first page, for example, the target component pops up.

It is considered that if the first user views the first target multimedia content for a relatively short duration, if the target component is displayed on the first page according to the preset first display time, it is likely that the user has already swiped away short video 2, that is, the first target multimedia content, while the target component has not been displayed yet. Therefore, in the present disclosure, the second display time of the target component is determined according to the expected playback duration and the preset first display time of the target component, and the second display time is used to indicate an opportunity to actually start displaying the target component on the first page in the process of playing the first target multimedia content in response to the first page being switched to, and the display opportunity of the target component may be advanced, thereby increasing the probability of the first user seeing the target component and increasing the click-through rate of the target component.

Through the above technical solution, the expected playback duration is the expected playback duration of the first user for the first target multimedia content, and the first target multimedia content is the multimedia content to be played in the first page after switching in response to the page switching operation implemented by the first user being received, that is, the playback duration of the first target multimedia content to be displayed may be estimated. The second display time of the target component is determined according to the expected playback duration and the preset first display time of the target component. In this way, if the preset first display time of the target component is later than the time corresponding to the expected playback duration, the display opportunity of the target component in the first page may be advanced. In response to the page switching operation implemented by the user being received, the display opportunity of the target component is advanced in the process of playing the first target multimedia content, which may increase the probability of the first user seeing the target component, thereby increasing the click-through rate of the target component.

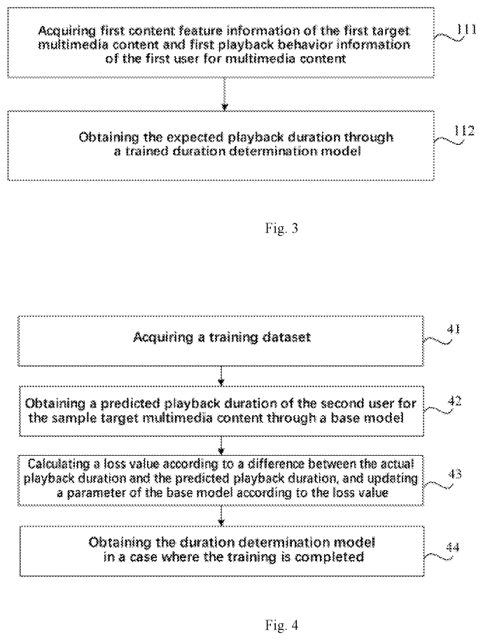

FIG. 3 is a flowchart of a method for determining an expected playback duration shown according to an exemplary embodiment, and as shown in FIG. 3, step 11 may include step 111 and step 112.

In step 111, first content feature information of the first target multimedia content and first playback behavior information of the first user for multimedia content are acquired.

In the present disclosure, the target multimedia content may include promotion content, that is, the target multimedia content is an advertisement video including the promotion content. The prerequisite for executing the method for determining display information of the present disclosure mentioned above may be that the multimedia content to be played in the first page after switching includes the promotion content.

Correspondingly, the first content feature information may include at least one of: promotion form information of the first target multimedia content, content duration of the first target multimedia content, and promotion effectiveness information of the first target multimedia content.

Specifically, the promotion form information is used to indicate whether an advertisement in the first target multimedia content is a soft advertisement or a hard advertisement. The hard advertisement is the most direct and obvious form of advertisement, and usually attracts the attention of the audience through pictures, videos, or texts with strong visual impact, and directly displays a product or service. The soft advertisement usually integrates product information into forms such as stories, case analyses, and user experiences, and implicitly promotes the product or service.

The content duration of the first target multimedia content, for example, the video duration of a short video is 60 seconds, which is also the duration of the complete playback of the video.

The promotion effectiveness information may include a click-through rate and/or a conversion rate. The click-through rate may be the click-through rate of the target component in the first target multimedia content, that is, an advertisement click-through rate, and the conversion rate may be the conversion rate of the promotion content in the first multimedia content, that is, an advertisement conversion rate. The server may estimate the click-through rate and/or the conversion rate of the first target multimedia content, and the electronic device may acquire the promotion effectiveness information from the server.

The first playback behavior information may include at least one of: a longest playback duration, a shortest playback duration, the number of times the target multimedia content has been played within a first specified time period, the number of times the target multimedia content has been browsed within a second specified time period, the number of times the multimedia content has been browsed within a third specified time period, and the number of times the target multimedia content has been completely played within a fourth specified time period.

The longest playback duration is the playback duration of a second target multimedia content, the shortest playback duration is the playback duration of a third target multimedia content, the second target multimedia content is multimedia content with the longest playback duration among a specified number of pieces of the target multimedia content that have been viewed by the first user, and the third target multimedia content is multimedia content with the shortest playback duration among the specified number of pieces of the target multimedia content.

Exemplarily, the target multimedia content is an advertisement video, and in response to the number of advertisement videos that have been recently browsed and played by the first user being greater than or equal to 10 from a time when the first user opens the application this time to a current moment, the specified number is 10, and the specified number of pieces of the target multimedia content that have been viewed by the first user are 10 advertisement videos that have been recently browsed and played by the first user. In response to the number of advertisement videos that have been recently browsed and played by the first user being less than 10, for example, 8, the specified number is 8. Taking the specified number being 10 as an example, the second target multimedia content is multimedia content with the longest playback duration among the 10 pieces of the target multimedia content, for example, the longest playback duration is 60 seconds, and the third target multimedia content is multimedia content with the shortest playback duration among the 10 pieces of the target multimedia content, for example, the shortest playback duration is 10 seconds.

The first specified time period includes, for example, a time period of 600 seconds, a time period of 80 seconds, and a time period of 40 seconds with the current moment as an end moment. The number of times the target multimedia content has been played within the first specified time period may include the number of times the first user has played the advertisement video within the last 600 seconds, the number of times the first user has played the advertisement video within the last 80 seconds, and the number of times the first user has played the advertisement video within the last 40 seconds, which are respectively used to reflect the playing situations of the first user for the advertisement video in different time periods. Exemplarily, taking the first specified time period being a time period of 400 seconds as an example, the first user has swiped to 10 advertisement videos within these 400 seconds, and each advertisement video is played (completely played or not completely played) once, then the number of times of being played is 10 times. As long as the video has a playback progress, it may be considered that the video has been effectively played, or the video is considered to have been effectively played if it has been played for a certain duration, which is not limited.

The second specified time period includes, for example, a time period of 1000 seconds with the current moment as the end moment, and the number of times the target multimedia content has been browsed within the second specified time period may include the number of times the first user has browsed the advertisement video within the last 1000 seconds. For a certain video swiped by the first user, if the video is not loaded or buffered completely, and the first user does not actually view or play the video, the video is considered to have been browsed by the first user, that is, the video is swiped away by the first user before it has time to be played. In addition, the video that has been viewed or played by the first user is also counted as a browsed video.

The third specified time period includes, for example, a time period of 400 seconds and a time period of 40 seconds with the current moment as the end moment, and the number of times the multimedia content has been browsed within the third specified time period may include the number of times the first user has browsed videos within the last 400 seconds and the number of times the first user has browsed videos within the last 40 seconds. The multimedia content may include the target multimedia content and ordinary multimedia content, and the ordinary multimedia content does not include promotion content, that is, the ordinary multimedia content is a non-advertisement video.

The fourth specified time period includes, for example, a time period of 400 seconds with the current moment as the end moment, and the number of times the target multimedia content has been completely played within the fourth specified time period may include the number of times the first user has completely played the advertisement video within the last 400 seconds. For example, 3 out of 10 advertisement videos have been completely played, and each video has been played once, then the number of times of being completely played is 3 times.

The above-mentioned number of times of being played and number of times of being browsed may be information recorded by the application in a process of the first user using the application. In addition, the duration of each specified time period is only exemplary and may be adjusted according to an actual scenario. For example, if the duration from the time when the first user opens the application this time to the current moment is less than 1000 seconds, the duration of the specified time period is the duration from the time when the application is opened to the current moment.

In step 112, the expected playback duration is obtained through a trained duration determination model.

The duration determination model is used to determine the expected playback duration according to the first content feature information and the first playback behavior information. A feature vector of the first content feature information and a feature vector of the first playback behavior information may be input into the duration determination model to obtain the expected playback duration output by the duration determination model.

In this way, the first content feature information may reflect the feature information of the first target multimedia content to be played. The first playback behavior information may reflect the viewing behavior of the first user for the target multimedia content, that is, the advertisement video. For example, whether the first user accepts or likes to watch advertisement videos may be reflected through the playback duration, the number of times of being played, and the number of times of being browsed. The first playback behavior information may also reflect the speed at which the first user switches the multimedia content (including advertisement videos and non-advertisement videos), that is, fast swiping or slow swiping. The first content feature information and the first playback behavior information may provide a basis for the duration determination model to determine the expected playback duration.

In the present disclosure, the duration determination model may be trained as shown in FIG. 4, which includes step 41 to step 44.

In step 41, a training dataset is acquired.

The training dataset includes second content feature information of sample target multimedia content, second playback behavior information of a second user for multimedia content, and an actual playback duration of the second user for the sample target multimedia content.

The sample target multimedia content includes promotion content. The second content feature information may include at least one of: promotion form information of the sample target multimedia content, content duration of the sample target multimedia content, and promotion effectiveness information of the sample target multimedia content.

The second playback behavior information may include at least one of: a playback duration of a fourth target multimedia content, a playback duration of a fifth target multimedia content, the number of times the target multimedia content has been played within a fifth specified time period, the number of times the target multimedia content has been browsed within a sixth specified time period, the number of times the multimedia content has been browsed within a seventh specified time period, and the number of times the target multimedia content has been completely played within an eighth specified time period. The fourth target multimedia content is multimedia content with the longest playback duration among a specified number of pieces of the target multimedia content that have been viewed by the second user, and the fifth target multimedia content is multimedia content with the shortest playback duration among the specified number of pieces of the target multimedia content that have been viewed by the second user.

The training dataset may include multiple training samples, and there may be multiple second users. Each training sample includes the second content feature information, the second playback behavior information, and the corresponding actual playback duration. Exemplarily, the training sample may be data collected in a process of the second user historically using the application, the above-mentioned fifth specified time period, sixth specified time period, seventh specified time period, and eighth specified time period are time periods in the process of the second user historically using the application, and the fourth target multimedia content and the fifth target multimedia content are multimedia content browsed in the process of the second user historically using the application. The number of times of being played, the number of times of being browsed, and the number of times of being completely played in the training sample may reflect the video viewing behavior of the second user in the process of historically using the application.

In an example, the second user may include the first user, that is, the training sample may include data of the first user historically using the application.

In step 42, a predicted playback duration of the second user for the sample target multimedia content is obtained through a base model, the base model being used to determine the predicted playback duration according to the second content feature information and the second playback behavior information.

In step 43, a loss value is calculated according to a difference between the actual playback duration and the predicted playback duration, and a parameter of the base model is updated according to the loss value.

Exemplarily, a feature vector of the second content feature information and a feature vector of the second playback behavior information may be input into the base model to obtain the predicted playback duration output by the base model. The structure of the base model is not limited, and the base model may be, for example, a large language model, a neural network model, etc., of any structure.

The loss value may be calculated according to the difference between the actual playback duration and the predicted playback duration, and the loss value may be calculated by referring to a loss function in the related art. The parameter of the base model is updated according to the loss value, and the update manner may be all-parameter update or part-parameter update.

In step 44, the duration determination model is obtained in response to the training being completed.

A training stop condition may be that all training samples have been traversed, or the loss value has converged, that is, the loss value is maximum or minimum, which may represent that the training is completed, and the trained duration determination model is obtained.

Through the above technical solution, the duration determination model may be obtained through training according to the second content feature information, the second playback behavior information, and the actual playback duration of the second user for the sample target multimedia content. The training process of the model may be executed on a server, and the trained duration determination model may be loaded into the electronic device, that is, the user terminal device. In addition, if the first user implements the page switching operation, the actual playback duration of the first user for the first target multimedia content may be collected, and the above-mentioned first content feature information, first playback form information, and the actual playback duration may be used as a training sample for subsequent fine-tuning or further training of the duration determination model.

In the present disclosure, one or more target components may be provided. In the case where one target component is provided, step 12 may include:
in response to the first display time being earlier than or equal to a time corresponding to the expected playback duration, the first display time is taken as the second display time; and
in response to the first display time being later than the time corresponding to the expected playback duration, the time corresponding to the expected playback duration is taken as the second display time.

The time corresponding to the expected playback duration means that when the first target multimedia content is played to the corresponding time, the playback duration is the expected playback duration. For example, if the expected playback duration is 3 seconds, the corresponding time is the third second.

The time corresponding to the expected playback duration is represented as t1, and the preset first display time of the target component is represented as t2. If t2 is earlier than or equal to t1, it means that if the target component is displayed at the preset time t2, it is expected that the first user has not yet swiped away the first target multimedia content when the target component is displayed, that is, it is expected that the first user may see the target component, so the preset first display time t2 is taken as the second display time. If t2 is later than t1, it means that if the target component is displayed at the preset time t2, it is expected that the first user has swiped away the first target multimedia content before the target component is displayed. Therefore, the display opportunity of the target component may be advanced, and t1 may be taken as the second display time.

As an example, in response to the preset first display time being the fifth second and the expected playback duration is 3 seconds, the third second may be taken as the second display time of the target component. In this way, the display opportunity of the target component may be advanced, and the target component may be displayed before it is expected that the first user swipes away the first target multimedia content, thereby increasing the probability of the first user seeing the target component.

In the present disclosure, in the case where multiple target components are provided, the multiple target components include a first target component and a second target component associated with the first target component, and the first target component is a component with an earliest preset first display time among the multiple target components.

Step 12 may include:
in response to the first display time of the first target component being earlier than or equal to the time corresponding to the expected playback duration, the first display time of the target component is taken as the second display time of the target component for each target component; and
in response to the first display time of the first target component being later than the time corresponding to the expected playback duration, the time corresponding to the expected playback duration is taken as the second display time of the first target component, and the second display time of the second target component is determined according to a time interval, the time interval being an interval between the first display time of the first target component and the time corresponding to the expected playback duration.

In one embodiment, the target component includes component 1, component 2, and component 3, where a preset first display time of component 1 is the second second, a first display time of component 2 is the third second, and a first display time of component 3 is the fourth second, then component 1 is a component with an earliest first display time, component 1 is taken as the first target component, component 2 and component 3 are components associated with component 1, component 2 and component 3 need to be displayed after component 1 is displayed, and component 2 and component 3 are taken as the second target component. In this example, for example, the expected playback duration is 3 seconds, and the first display time of component 1 is earlier than the time corresponding to the expected playback duration, the first display times of component 1, component 2, and component 3 are respectively taken as second display times, that is, a second display time of component 1 is the second second, a second display time of component 2 is the third second, and a second display time of component 3 is the fourth second.

In another embodiment, the preset first display time of component 1 is the fifth second, the first display time of component 2 is the seventh second, and the first display time of component 3 is the tenth second, component 1 is taken as the first target component, and component 2 and component 3 are taken as the second target component. In this example, for example, the expected playback duration is 3 seconds, and the first display time of component 1 is later than the time corresponding to the expected playback duration, the third second corresponding to the expected playback duration is taken as the second display time of component 1. The interval between the first display time of the first target component, that is, the fifth second, and the time corresponding to the expected playback duration, that is, the third second, is 2 seconds.

The determining the second display time of the second target component according to the time interval includes:
taking a third display time as the second display time of the second target component, the third display time being earlier than the first display time of the second target component, and an interval between the third display time and the first display time of the second target component being the time interval.

Exemplarily, for component 2, the display time of component 2 is advanced by 2 seconds according to the time interval of 2 seconds, and the third display time is the fifth second, then the second display time of component 2 is the fifth second. For component 3, the display time of component 3 is advanced by 2 seconds, and the third display time is the eighth second, then the second display time of component 3 is the eighth second.

Through the above technical solution, the display opportunity of the first target component may be advanced, and the display opportunity of the second target component is adjusted accordingly according to the time interval, so as to ensure that the display time interval between the multiple target components is kept unchanged, thereby ensuring a preset continuous rendering effect of the multiple components.

In the present disclosure, after step 12, the method for determining display information may further include:
playing the first target multimedia content on the first page in response to receiving the page switching operation; and
displaying the target component on the first page when the first target multimedia content is played to the second display time.

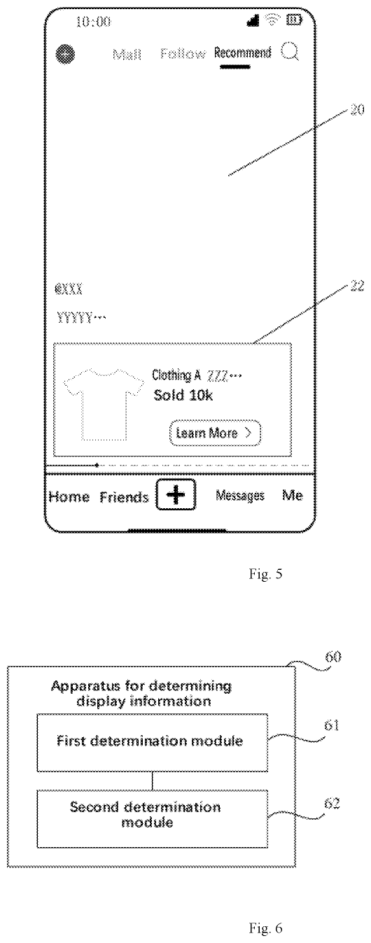

As shown in FIG. 2, in response to the page switching operation implemented by the first user being received, the first page 20 may be displayed, and the first target multimedia content is played on the first page 20. For example, if the second display time of component 21 is the third second, component 21 is displayed on the first page when the first target multimedia content is played to the third second. FIG. 5 is a schematic diagram of a first page shown as an example, and as shown in FIG. 5, the target component further includes component 22, component 22 may be an associated component of component 21, and component 22 is displayed after component 21. For example, if the second display time of component 22 is the fifth second, component 21 is not displayed on the first page 20, and component 22 is displayed on the first page 20 when the first target multimedia content is played to the fifth second. Component 22 may be more obvious than component 21 and more easily noticed by the first user. The reason for setting multiple target components is that if the user stays on the page for a period of time, the user may be interested in the corresponding advertisement, and the component may be replaced with a component with a more prominent display effect, so as to increase the click-through rate and conversion rate of the advertisement.

It should be noted that in the embodiments described in the present disclosure, the target component being an advertisement component is taken as an example for illustration only, and the target component may also be a news push component, a component for interacting with the user, and the component for interacting with the user is, for example, an Easter egg, a component with an effect, etc.

Through the above technical solution, in response to the page switching operation implemented by the user being received, the display opportunity of the target component is advanced in the process of playing the first target multimedia content, which may increase the probability of the first user seeing the target component, thereby increasing the click-through rate of the target component.

Based on the same inventive concept, the present disclosure further provides an apparatus for determining display information, FIG. 6 is a block diagram of an apparatus for determining display information shown according to an exemplary embodiment, and as shown in FIG. 6, the apparatus 60 may include:
a first determination module 61, configured to determine an expected playback duration, the expected playback duration is an expected playback duration of a first user for a first target multimedia content, the first target multimedia content is multimedia content to be played in a first page after switching in response to a page switching operation implemented by the first user being received; and
a second determination module 62, configured to determine a second display time of a target component according to the expected playback duration and a preset first display time of the target component, where the display time of the target component is used to indicate an opportunity to start displaying the target component on the first page in a process of playing the first target multimedia content, and the target component is used to trigger display of a landing page associated with the first target multimedia content.

Optionally, the first determination module 61 includes:
an acquisition sub-module, configured to acquire first content feature information of the first target multimedia content and first playback behavior information of the first user for multimedia content; and
an obtaining sub-module, configured to obtain the expected playback duration through a trained duration determination model, the duration determination model being configured to determine the expected playback duration according to the first content feature information and the first playback behavior information.

Optionally, the target multimedia content includes promotion content;
the first content feature information includes at least one of: promotion form information of the first target multimedia content, content duration of the first target multimedia content, and promotion effectiveness information of the first target multimedia content; and
the first playback behavior information includes at least one of: a longest playback duration, a shortest playback duration, the number of times the target multimedia content has been played within a first specified time period, the number of times the target multimedia content has been browsed within a second specified time period, the number of times the multimedia content has been browsed within a third specified time period, and the number of times the target multimedia content has been completely played within a fourth specified time period;
the longest playback duration is a playback duration of a second target multimedia content, the shortest playback duration is a playback duration of a third target multimedia content, the second target multimedia content is multimedia content with a longest playback duration among a specified number of pieces of the target multimedia content that have been viewed by the first user, and the third target multimedia content is multimedia content with a shortest playback duration among the specified number of pieces of the target multimedia content.

Optionally, the duration determination model is trained through modules as follows:
an acquisition module, configured to acquire a training dataset, the training dataset including second content feature information of sample target multimedia content, second playback behavior information of a second user for multimedia content, and an actual playback duration of the second user for the sample target multimedia content;
a first obtaining module, configured to obtain a predicted playback duration of the second user for the sample target multimedia content through a base model, the base model being configured to determine the predicted playback duration according to the second content feature information and the second playback behavior information;
a training module, configured to calculate a loss value according to a difference between the actual playback duration and the predicted playback duration, and update a parameter of the base model according to the loss value; and
   a second obtaining module, configured to obtain the duration determination model in response to the training being completed.

Optionally, one target component is provided; and
the second determination module 62 includes:
   a first determination sub-module, configured to take the first display time as the second display time in response to the first display time being earlier than or equal to a time corresponding to the expected playback duration; and
   a second determination sub-module, configured to take the time corresponding to the expected playback duration as the second display time in response to the first display time being later than the time corresponding to the expected playback duration.

Optionally, multiple target components are provided, the multiple target components include a first target component and a second target component associated with the first target component, and the first target component is a component with an earliest preset first display time among the multiple target components; and
the second determination module 62 includes:
   a third determination sub-module, configured to take the first display time of the target component as the second display time of the target component for each target component in response to the first display time of the first target component being earlier than or equal to the time corresponding to the expected playback duration; and
a fourth determination sub-module, configured to take the time corresponding to the expected playback duration as the second display time of the first target component in response to the first display time of the first target component being later than the time corresponding to the expected playback duration, and determine the second display time of the second target component according to a time interval, the time interval being an interval between the first display time of the first target component and the time corresponding to the expected playback duration.

Optionally, the fourth determination sub-module is configured to:
take a third display time as the second display time of the second target component, the third display time being earlier than the first display time of the second target component, and an interval between the third display time and the first display time of the second target component being the time interval.

Optionally, the apparatus 60 further includes:
a playback module, configured to play the first target multimedia content on the first page in response to receiving the page switching operation after the second determination module 62 determines the second display time of the target component according to the expected playback duration and the preset first display time of the target component; and
a display module, configured to display the target component on the first page when the first target multimedia content is played to the second display time.

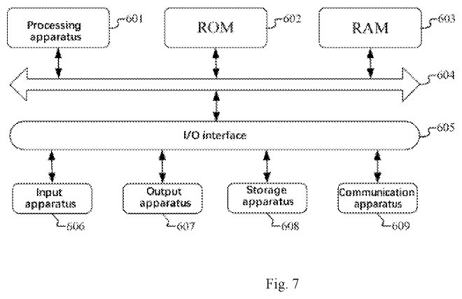

Reference is made to FIG. 7 below, which illustrates a schematic structural diagram of an electronic device 600 suitable for implementing the embodiments of the present disclosure. The terminal device in the embodiments of the present disclosure may include, but is not limited to, a mobile terminal such as a mobile phone, a notebook computer, a digital broadcast receiver, a personal digital assistant (PDA), a tablet computer, a portable multimedia player (PMP), a vehicle-mounted terminal (such as a vehicle navigation terminal), etc., and a stationary terminal such as a digital television (TV), a desktop computer, etc. The electronic device shown in FIG. 7 is only an example, and should not impose any limitation on the function and scope of use of the embodiments of the present disclosure.

As shown in FIG. 7, the electronic device 600 may include a processing apparatus (such as a central processing unit, a graphics processing unit, etc.) 601, which may perform various appropriate actions and processing according to a program stored in a read-only memory (ROM) 602 or a program loaded from a storage apparatus 608 into a random access memory (RAM) 603. The RAM 603 further stores various programs and data required for the operation of the electronic device 600. The processing apparatus 601, the ROM 602, and the RAM 603 are connected to each other through a bus 604. An input/output (I/O) interface 605 is also connected to the bus 604.

Usually, the following apparatuses may be connected to the I/O interface 605: an input apparatus 606 including, for example, a touch screen, a touchpad, a keyboard, a mouse, a camera, a microphone, an accelerometer, a gyroscope, etc.; an output apparatus 607 including, for example, a liquid crystal display (LCD), a speaker, a vibrator, etc.; a storage apparatus 608 including, for example, a magnetic tape, a hard disk, etc.; and a communication apparatus 609. The communication apparatus 609 may allow the electronic device 600 to perform wireless or wired communication with other devices to exchange data. Although FIG. 7 shows the electronic device 600 having various apparatuses, it should be understood that it is not required to implement or have all the apparatuses shown. More or fewer apparatuses may be implemented or provided alternatively.

In particular, according to the embodiments of the present disclosure, the process described above with reference to the flowchart may be implemented as a computer software program. For example, the embodiments of the present disclosure include a computer program product, which includes a computer program carried on a non-transitory computer-readable medium, the computer program including program code for executing the method shown in the flowchart. In such an embodiment, the computer program may be downloaded and installed from a network through the communication apparatus 609, or installed from the storage apparatus 608, or installed from the ROM 602. When the computer program is executed by the processing apparatus 601, the above-mentioned functions defined in the method of the embodiments of the present disclosure are executed.

It should be noted that the above-mentioned computer-readable medium in the present disclosure may be a computer-readable signal medium, a computer-readable storage medium, or any combination thereof. The computer-readable storage medium may be, for example, but not limited to, an electrical, magnetic, optical, electromagnetic, infrared, or semiconductor system, apparatus or device, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program, and the program may be used by or in combination with an instruction execution system, apparatus, or device. In the present disclosure, the computer-readable signal medium may include a data signal propagated in a baseband or as a part of a carrier wave, and computer-readable program code is carried therein. This propagated data signal may take multiple forms, including but not limited to, an electromagnetic signal, an optical signal, or any suitable combination of the above. The computer-readable signal medium may also be any computer-readable medium other than the computer-readable storage medium, and the computer-readable signal medium may send, propagate, or transmit a program used by or in combination with an instruction execution system, apparatus, or device. The program code contained on the computer-readable medium may be transmitted by any suitable medium, including but not limited to: a wire, an optical cable, a radio frequency (RF), etc., or any suitable combination of the above.

In some implementations, a client may communicate using any currently known or future developed network protocol, such as the HyperText Transfer Protocol (HTTP), and may be interconnected with any form or medium of digital data communication (for example, a communication network). Examples of the communication network include a local area network (“LAN”), a wide area network (“WAN”), an internet (for example, the Internet), a peer-to-peer network (for example, an Ad-Hoc network), and any network currently known or to be developed in the future.

The above-mentioned computer-readable medium may be included in the above-mentioned electronic device, or may exist alone without being assembled into the electronic device.

The above-mentioned computer-readable medium carries one or more programs, which, when executed by the electronic device, cause the electronic device to: determine an expected playback duration, the expected playback duration is an expected playback duration of a first user for a first target multimedia content, the first target multimedia content is multimedia content to be played in a first page after switching in response to a page switching operation implemented by the first user being received; and
determine a second display time of a target component according to the expected playback duration and a preset first display time of the target component, where the display time of the target component is used to indicate an opportunity to start displaying the target component on the first page in a process of playing the first target multimedia content, and the target component is used to trigger display of a landing page associated with the first target multimedia content.

The computer program code for performing the operations of the present disclosure may be written in one or more programming languages or a combination thereof, the programming languages including but not limited to object-oriented programming languages such as Java, Smalltalk, C++, and conventional procedural programming languages such as “C” language or similar programming languages. The program code may be executed entirely on a user computer, partly on the user computer, as a stand-alone software package, partly on the user computer and partly on a remote computer, or entirely on the remote computer or a server. In the case of involving the remote computer, the remote computer may be connected to the user computer through any kind of network, including a local area network (LAN) or a wide area network (WAN), or may be connected to an external computer (for example, connected through the Internet with the aid of an Internet service provider).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The modules involved in the embodiments of the present disclosure may be implemented by software or by hardware. Among them, the name of the module does not constitute a limitation on the module itself under certain circumstances, for example, the first determination module may also be described as “a module for determining an expected playback duration”.

The functions described above herein may be performed at least in part by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above. More specific examples of the machine-readable storage medium may include an electrical connection based on one or more lines, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

According to one or more embodiments of the present disclosure, Example 1 provides a method for determining display information, the method includes:
determining an expected playback duration, the expected playback duration is an expected playback duration of a first user for a first target multimedia content, the first target multimedia content is multimedia content to be played in a first page after switching in response to a page switching operation implemented by the first user being received; and
determining a second display time of a target component according to the expected playback duration and a preset first display time of the target component, where the display time of the target component is used to indicate an opportunity to start displaying the target component on the first page in a process of playing the first target multimedia content, and the target component is used to trigger display of a landing page associated with the first target multimedia content.

According to one or more embodiments of the present disclosure, Example 2 provides the method of Example 1, the determining the expected playback duration includes:
acquiring first content feature information of the first target multimedia content and first playback behavior information of the first user for multimedia content; and
obtaining the expected playback duration through a trained duration determination model, the duration determination model being configured to determine the expected playback duration according to the first content feature information and the first playback behavior information.

According to one or more embodiments of the present disclosure, Example 3 provides the method of Example 2, target multimedia content includes promotion content;
the first content feature information includes at least one of: promotion form information of the first target multimedia content, content duration of the first target multimedia content, and promotion effectiveness information of the first target multimedia content; and
the first playback behavior information includes at least one of: a longest playback duration, a shortest playback duration, the number of times the target multimedia content has been played within a first specified time period, the number of times the target multimedia content has been browsed within a second specified time period, the number of times the multimedia content has been browsed within a third specified time period, and the number of times the target multimedia content has been completely played within a fourth specified time period;
the longest playback duration is a playback duration of a second target multimedia content, the shortest playback duration is a playback duration of a third target multimedia content, the second target multimedia content is multimedia content with a longest playback duration among a specified number of pieces of the target multimedia content that have been viewed by the first user, and the third target multimedia content is multimedia content with a shortest playback duration among the specified number of pieces of the target multimedia content.

According to one or more embodiments of the present disclosure, Example 4 provides the method of Example 2, the duration determination model is trained as follows:
acquiring a training dataset, the training dataset including second content feature information of sample target multimedia content, second playback behavior information of a second user for multimedia content, and an actual playback duration of the second user for the sample target multimedia content;
obtaining a predicted playback duration of the second user for the sample target multimedia content through a base model, the base model being configured to determine the predicted playback duration according to the second content feature information and the second playback behavior information;
calculating a loss value according to a difference between the actual playback duration and the predicted playback duration, and updating a parameter of the base model according to the loss value; and
obtaining the duration determination model in response to the training being completed.

According to one or more embodiments of the present disclosure, Example 5 provides the method of Example 1, one target component is provided; and
the determining the second display time of the target component according to the expected playback duration and the preset first display time of the target component includes:
in response to the first display time being earlier than or equal to a time corresponding to the expected playback duration, the first display time is taken as the second display time; and
in response to the first display time being later than the time corresponding to the expected playback duration, the time corresponding to the expected playback duration is taken as the second display time.

According to one or more embodiments of the present disclosure, Example 6 provides the method of Example 1, multiple target components are provided, the multiple target components include a first target component and a second target component associated with the first target component, and the first target component is a component with an earliest preset first display time among the multiple target components; and
the determining the second display time of the target component according to the expected playback duration and the preset first display time of the target component includes:
in response to the first display time of the first target component being earlier than or equal to the time corresponding to the expected playback duration, the first display time of the target component is taken as the second display time of the target component for each target component; and
in response to the first display time of the first target component being later than the time corresponding to the expected playback duration, the time corresponding to the expected playback duration is taken as the second display time of the first target component, and the second display time of the second target component is determined according to a time interval, the time interval being an interval between the first display time of the first target component and the time corresponding to the expected playback duration.

According to one or more embodiments of the present disclosure, Example 7 provides the method of Example 6, the determining the second display time of the second target component according to the time interval includes:
taking a third display time as the second display time of the second target component, the third display time being earlier than the first display time of the second target component, and an interval between the third display time and the first display time of the second target component being the time interval.

According to one or more embodiments of the present disclosure, Example 8 provides the method of Example 1, after the step of determining the second display time of the target component according to the expected playback duration and the preset first display time of the target component, the method further includes:
playing the first target multimedia content on the first page in response to receiving the page switching operation; and
displaying the target component on the first page when the first target multimedia content is played to the second display time.

According to one or more embodiments of the present disclosure, Example 9 provides an apparatus for determining display information, the apparatus includes:
a first determination module, configured to determine an expected playback duration, the expected playback duration is an expected playback duration of a first user for a first target multimedia content, the first target multimedia content is multimedia content to be played in a first page after switching in response to a page switching operation implemented by the first user being received; and
a second determination module, configured to determine a second display time of a target component according to the expected playback duration and a preset first display time of the target component, where the display time of the target component is used to indicate an opportunity to start displaying the target component on the first page in a process of playing the first target multimedia content, and the target component is used to trigger display of a landing page associated with the first target multimedia content.

According to one or more embodiments of the present disclosure, Example 10 provides a computer-readable medium having a computer program stored thereon, where the computer program, when executed by a processing apparatus, implements the steps of the method described in any one of Examples 1 to 8.

According to one or more embodiments of the present disclosure, Example 11 provides an electronic device, including:
a storage apparatus having a computer program stored thereon; and
a processing apparatus, configured to execute the computer program in the storage apparatus to implement the steps of the method described in any one of Examples 1 to 8.

According to one or more embodiments of the present disclosure, Example 12 provides a computer program product including a computer program, where the computer program, when executed by a processor, implements the steps of the method described in any one of Examples 1 to 8.

The above description is only preferred embodiments of the present disclosure and an explanation of the applied technical principles. Those skilled in the art should understand that the disclosed scope involved in the present disclosure is not limited to the technical solution formed by the specific combination of the above technical features, but also covers other technical solutions formed by any combination of the above technical features or their equivalent features without departing from the above disclosed concept. For example, the above features and the technical features disclosed in the present disclosure (but not limited to) with similar functions are replaced each other to form a technical solution.

Furthermore, although the various operations are depicted in a specific order, this should not be understood as requiring the operations to be performed in the specific order shown or in a sequential order. Under certain circumstances, multitasking and parallel processing may be beneficial. Likewise, although several specific implementation details are included in the above discussion, these should not be interpreted as limiting the scope of the present disclosure. Certain features that are described in the context of separate embodiments may also be implemented in combination in a single embodiment. On the contrary, various features described in the context of a single embodiment may also be implemented in multiple embodiments individually or in any suitable sub-combination.

Although the subject matter has been described in a language specific to the structural features and/or method logic actions, it should be understood that the subject matter defined in the appended claims is not necessarily limited to the specific features or actions described above. On the contrary, the specific features and actions described above are only exemplary forms for implementing the claims. Regarding the apparatus in the above embodiments, the specific manner in which each module performs an operation has been described in detail in the embodiments relating to the method, and will not be detailed herein.

1. A method for determining display information, comprising:
determining an expected playback duration, wherein the expected playback duration is an expected playback duration of a first user for a first multimedia content of a first type and the first multimedia content of the first type is multimedia content to be played in a first page after switching in response to a page switching operation implemented by the first user being received; and
determining a second display time of a component according to the expected playback duration and a preset first display time of the component, wherein the display time of the component is used to indicate an opportunity to start displaying the component on the first page in a process of playing the first multimedia content of the first type, and the component is used to trigger display of a landing page associated with the first multimedia content of the first type.

2. The method of claim 1, wherein the determining the expected playback duration comprises:
acquiring first content feature information of the first multimedia content of the first type and first playback behavior information of the first user for multimedia content; and
obtaining the expected playback duration through a trained duration determination model, the duration determination model being configured to determine the expected playback duration according to the first content feature information and the first playback behavior information.

3. The method of claim 2, wherein multimedia content of the first type comprises promotion content;
the first content feature information comprises at least one of: promotion form information of the first multimedia content of the first type, content duration of the first multimedia content of the first type, and promotion effectiveness information of the first multimedia content of the first type; and
the first playback behavior information comprises at least one of: a longest playback duration, a shortest playback duration, the number of times the multimedia content of the first type has been played within a first specified time period, the number of times the multimedia content of the first type has been browsed within a second specified time period, the number of times the multimedia content has been browsed within a third specified time period, and the number of times the multimedia content of the first type has been completely played within a fourth specified time period;
wherein the longest playback duration is a playback duration of a second multimedia content of the first type, the shortest playback duration is a playback duration of a third multimedia content of the first type, the second multimedia content of the first type is the multimedia content with a longest playback duration among a specified number of pieces of the multimedia content of the first type that have been viewed by the first user, and the third multimedia content of the first type is the multimedia content with a shortest playback duration among the specified number of pieces of the multimedia content of the first type.

4. The method of claim 2, wherein the duration determination model is trained as follows:
acquiring a training dataset, the training dataset comprising second content feature information of sample multimedia content of the first type, second playback behavior information of a second user for multimedia content, and an actual playback duration of the second user for the sample multimedia content of the first type;
obtaining a predicted playback duration of the second user for the sample multimedia content of the first type through a base model, the base model being configured to determine the predicted playback duration according to the second content feature information and the second playback behavior information;
calculating a loss value according to a difference between the actual playback duration and the predicted playback duration, and updating a parameter of the base model according to the loss value; and
obtaining the duration determination model in response to the training being completed.

5. The method of claim 1, wherein one component is provided; and
the determining the second display time of the component according to the expected playback duration and the preset first display time of the component comprises:
in response to the first display time being earlier than or equal to a time corresponding to the expected playback duration, the first display time is taken as the second display time; and
in response to the first display time being later than the time corresponding to the expected playback duration, the time corresponding to the expected playback duration is taken as the second display time.

6. The method of claim 1, wherein multiple components are provided, the multiple components comprise a first component and a second component associated with the first component, and the first component is a component with an earliest preset first display time among the multiple components; and
the determining the second display time of the component according to the expected playback duration and the preset first display time of the component comprises:
in response to the first display time of the first component being earlier than or equal to the time corresponding to the expected playback duration, the first display time of the component is taken as the second display time of the component for each component; and
in response to the first display time of the first component being later than the time corresponding to the expected playback duration, the time corresponding to the expected playback duration is taken as the second display time of the first component, and the second display time of the second component is determined according to a time interval, the time interval being an interval between the first display time of the first component and the time corresponding to the expected playback duration.

7. The method of claim 6, wherein the determining the second display time of the second component according to the time interval comprises:
taking a third display time as the second display time of the second component, the third display time being earlier than the first display time of the second component, and an interval between the third display time and the first display time of the second component being the time interval.

8. The method of claim 1, wherein after the step of determining the second display time of the component according to the expected playback duration and the preset first display time of the component, the method further comprises:
playing the first multimedia content of the first type on the first page in response to receiving the page switching operation; and
displaying the component on the first page in response to the first multimedia content of the first type being played to the second display time.

9. A non-transitory computer-readable medium having a computer program stored thereon, wherein the computer program, when executed by at least one processing apparatus, implements a method for determining display information, comprising:
determining an expected playback duration, wherein the expected playback duration is an expected playback duration of a first user for a first multimedia content of a first type and the first multimedia content of the first type is multimedia content to be played in a first page after switching in response to a page switching operation implemented by the first user being received; and
determining a second display time of a component according to the expected playback duration and a preset first display time of the component, wherein the display time of the component is used to indicate an opportunity to start displaying the component on the first page in a process of playing the first multimedia content of the first type, and the component is used to trigger display of a landing page associated with the first multimedia content of the first type.

10. The non-transitory computer-readable medium of claim 9, wherein the determining the expected playback duration comprises:
acquiring first content feature information of the first multimedia content of the first type and first playback behavior information of the first user for multimedia content; and
obtaining the expected playback duration through a trained duration determination model, the duration determination model being configured to determine the expected playback duration according to the first content feature information and the first playback behavior information.

11. The non-transitory computer-readable medium of claim 10, wherein multimedia content of the first type comprises promotion content;
the first content feature information comprises at least one of: promotion form information of the first multimedia content of the first type, content duration of the first multimedia content of the first type, and promotion effectiveness information of the first multimedia content of the first type; and
the first playback behavior information comprises at least one of: a longest playback duration, a shortest playback duration, the number of times the multimedia content of the first type has been played within a first specified time period, the number of times the multimedia content of the first type has been browsed within a second specified time period, the number of times the multimedia content has been browsed within a third specified time period, and the number of times the multimedia content of the first type has been completely played within a fourth specified time period;
wherein the longest playback duration is a playback duration of a second multimedia content of the first type, the shortest playback duration is a playback duration of a third multimedia content of the first type, the second multimedia content of the first type is the multimedia content with a longest playback duration among a specified number of pieces of the multimedia content of the first type that have been viewed by the first user, and the third multimedia content of the first type is the multimedia content with a shortest playback duration among the specified number of pieces of the multimedia content of the first type.

12. The non-transitory computer-readable medium of claim 10, wherein the duration determination model is trained as follows:
acquiring a training dataset, the training dataset comprising second content feature information of sample multimedia content of the first type, second playback behavior information of a second user for multimedia content, and an actual playback duration of the second user for the sample multimedia content of the first type;
obtaining a predicted playback duration of the second user for the sample multimedia content of the first type through a base model, the base model being configured to determine the predicted playback duration according to the second content feature information and the second playback behavior information;
calculating a loss value according to a difference between the actual playback duration and the predicted playback duration, and updating a parameter of the base model according to the loss value; and
obtaining the duration determination model in response to the training being completed.

13. The non-transitory computer-readable medium of claim 9, wherein one component is provided; and
the determining the second display time of the component according to the expected playback duration and the preset first display time of the component comprises:
in response to the first display time being earlier than or equal to a time corresponding to the expected playback duration, the first display time is taken as the second display time; and
in response to the first display time being later than the time corresponding to the expected playback duration, the time corresponding to the expected playback duration is taken as the second display time.

14. The non-transitory computer-readable medium of claim 9, wherein multiple components are provided, the multiple components comprise a first component and a second component associated with the first component, and the first component is a component with an earliest preset first display time among the multiple components; and
the determining the second display time of the component according to the expected playback duration and the preset first display time of the component comprises:
in response to the first display time of the first component being earlier than or equal to the time corresponding to the expected playback duration, the first display time of the component is taken as the second display time of the component for each component; and
in response to the first display time of the first component being later than the time corresponding to the expected playback duration, the time corresponding to the expected playback duration is taken as the second display time of the first component, and the second display time of the second component is determined according to a time interval, the time interval being an interval between the first display time of the first component and the time corresponding to the expected playback duration.

15. An electronic device, characterized by comprising:
at least one storage apparatus having a computer program stored thereon; and
at least one processing apparatus, configured to execute the computer program in the at least one storage apparatus to implement a method for determining display information, comprising:
determining an expected playback duration, wherein the expected playback duration is an expected playback duration of a first user for a first multimedia content of a first type and the first multimedia content of the first type is multimedia content to be played in a first page after switching in response to a page switching operation implemented by the first user being received; and
determining a second display time of a component according to the expected playback duration and a preset first display time of the component, wherein the display time of the component is used to indicate an opportunity to start displaying the component on the first page in a process of playing the first multimedia content of the first type, and the component is used to trigger display of a landing page associated with the first multimedia content of the first type.

16. The device of claim 15, wherein the determining the expected playback duration comprises:
acquiring first content feature information of the first multimedia content of the first type and first playback behavior information of the first user for multimedia content; and
obtaining the expected playback duration through a trained duration determination model, the duration determination model being configured to determine the expected playback duration according to the first content feature information and the first playback behavior information.

17. The device of claim 16, wherein multimedia content of the first type comprises promotion content;
the first content feature information comprises at least one of: promotion form information of the first multimedia content of the first type, content duration of the first multimedia content of the first type, and promotion effectiveness information of the first multimedia content of the first type; and
the first playback behavior information comprises at least one of: a longest playback duration, a shortest playback duration, the number of times the multimedia content of the first type has been played within a first specified time period, the number of times the multimedia content of the first type has been browsed within a second specified time period, the number of times the multimedia content has been browsed within a third specified time period, and the number of times the multimedia content of the first type has been completely played within a fourth specified time period;
wherein the longest playback duration is a playback duration of a second multimedia content of the first type, the shortest playback duration is a playback duration of a third multimedia content of the first type, the second multimedia content of the first type is the multimedia content with a longest playback duration among a specified number of pieces of the multimedia content of the first type that have been viewed by the first user, and the third multimedia content of the first type is the multimedia content with a shortest playback duration among the specified number of pieces of the multimedia content of the first type.

18. The device of claim 16, wherein the duration determination model is trained as follows:
acquiring a training dataset, the training dataset comprising second content feature information of sample multimedia content of the first type, second playback behavior information of a second user for multimedia content, and an actual playback duration of the second user for the sample multimedia content of the first type;
obtaining a predicted playback duration of the second user for the sample multimedia content of the first type through a base model, the base model being configured to determine the predicted playback duration according to the second content feature information and the second playback behavior information;
calculating a loss value according to a difference between the actual playback duration and the predicted playback duration, and updating a parameter of the base model according to the loss value; and
obtaining the duration determination model in response to the training being completed.

19. The device of claim 15, wherein one component is provided; and
the determining the second display time of the component according to the expected playback duration and the preset first display time of the component comprises:
in response to the first display time being earlier than or equal to a time corresponding to the expected playback duration, the first display time is taken as the second display time; and
in response to the first display time being later than the time corresponding to the expected playback duration, the time corresponding to the expected playback duration is taken as the second display time.

20. The device of claim 15, wherein multiple components are provided, the multiple components comprise a first component and a second component associated with the first component, and the first component is a component with an earliest preset first display time among the multiple components; and
the determining the second display time of the component according to the expected playback duration and the preset first display time of the component comprises:
in response to the first display time of the first component being earlier than or equal to the time corresponding to the expected playback duration, the first display time of the component is taken as the second display time of the component for each component; and
in response to the first display time of the first component being later than the time corresponding to the expected playback duration, the time corresponding to the expected playback duration is taken as the second display time of the first component, and the second display time of the second component is determined according to a time interval, the time interval being an interval between the first display time of the first component and the time corresponding to the expected playback duration. wherein multiple components are provided, the multiple components comprise a first component and a second component associated with the first component, and the first component is a component with an earliest preset first display time among the multiple components; and
the determining the second display time of the component according to the expected playback duration and the preset first display time of the component comprises:
in response to the first display time of the first component being earlier than or equal to the time corresponding to the expected playback duration, the first display time of the component is taken as the second display time of the component for each component; and
in response to the first display time of the first component being later than the time corresponding to the expected playback duration, the time corresponding to the expected playback duration is taken as the second display time of the first component, and the second display time of the second component is determined according to a time interval, the time interval being an interval between the first display time of the first component and the time corresponding to the expected playback duration.
